(19) United States
(12) Patent Application Publication
(10) Pub. No.: US 2015/0371269 A1
(43) Pub. Date: Dec. 24, 2015

(54) PROVIDING CONTENT BASED ON GEOGRAPHIC LOCATION DATA

(71) Applicants: Rohan Seth, San Francisco, CA (US); Joshua J. Sacks, Woodside, CA (US); Michele Covell, Palo Alto, CA (US); Michael Chu, Los Altos, CA (US); David Marwood, San Francisco, CA (US); Shumeet Baluja, Leesburg, VA (US)

(72) Inventors: Rohan Seth, San Francisco, CA (US); Joshua J. Sacks, Woodside, CA (US); Michele Covell, Palo Alto, CA (US); Michael Chu, Los Altos, CA (US); David Marwood, San Francisco, CA (US); Shumeet Baluja, Leesburg, VA (US)

(73) Assignee: GOOGLE INC., Mountain View, CA (US)

(21) Appl. No.: 13/598,929

(22) Filed: Aug. 30, 2012

(51) Int. Cl. G06Q 30/02; G06F 17/30

(52) U.S. Cl. CPC G06Q 30/0261; G06F 17/30241

(57) ABSTRACT

Methods, system, and apparatus, including computer programs are encoded on a computer storage medium, for providing content based on geographic location data. In one aspect, a method includes receiving a request from a website for a map segment corresponding to a particular location. Keywords are extracted from the website as targeting criteria for the particular location. The targeting criteria is associated with the particular location. A subsequent request for advertising content associated with the particular location is received. One or more advertising content items are selected based on the targeting criteria. The selected advertising content items are provided responsive to the subsequent request.

### TECHNICAL FIELD

In general, this specification relates to information presentation.

### BACKGROUND

Interactive media (e.g., the Internet) has great potential for improving the targeting of content (e.g., advertisements, sometimes referred to as “ads”) to receptive audiences. For example, some websites provide information search functionality that is based on keywords entered by the user seeking information. A user query can be an indicator of the type of information of interest to the user. By comparing the user query to a list of keywords specified by an advertiser, it is possible to provide targeted ads to the user.

Another form of online advertising is ad syndication, which allows advertisers to extend their marketing reach by distributing ads to additional partners. For example, third party online publishers can place an advertiser's text or image ads on web properties with desirable content to drive online customers to the advertiser's website.

### SUMMARY

In general, one innovative aspect of the subject matter described in this specification may be embodied in methods that include the actions of receiving a request from a website for a map segment corresponding to a particular location. Keywords are extracted from the website as targeting criteria for the particular location. The targeting criteria is associated with the particular location. A subsequent request for advertising content associated with the particular location is received. One or more advertising content items are selected based on the targeting criteria. The selected advertising content items are provided responsive to the subsequent request.

These and other embodiments can each optionally include one or more of the following features. In some implementations, the targeting criteria comprises a Uniform Resource Locator (URL) of the website. In some implementations, associating the targeting criteria with the particular location includes associating the targeting criteria with a map cell that includes the particular location. In some implementations, selecting one or more advertising content items based on the targeting criteria includes selecting the one or more advertising content items based on the targeting criteria associated with the map cell that includes the particular location.

In general another innovative aspect of the subject matter described in this specification may be embodied in methods that include receiving a request for advertising content associated with a location. The location is mapped to a map cell. Targeting criteria is obtained for a map cell. The targeting criteria is extracted from a website that displays a map that includes the map cell or a related map cell. One or more advertising content items based on the targeting criteria are selected. The selected advertising content items responsive to the subsequent request are provided.

These and other embodiments can each optionally include one or more of the following features. In some implementations, obtaining targeting criteria for the map cell includes determining that the map cell is not associated with any targeting criteria; determining that a related map cell is associated with targeting criteria; and obtaining the targeting criteria from the related map cell. In some implementations, the related map cell is a parent of the map cell that includes the map cell or a child of the map cell. In some implementations, the methods include weighting the targeting criteria obtained from the related map cell.

Other embodiments of these aspects include corresponding systems, apparatus, and computer programs, configured to perform the actions of the methods, encoded on computer storage devices.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an example system for providing content based on geographic location data.

FIG. 2 is a flow chart of an example process for providing content based on geographic location data.

FIG. 3 is a diagram of an example organization of information that relates to the management of computing resources.

Like reference symbols in the various drawings indicate like elements.

### DETAILED DESCRIPTION

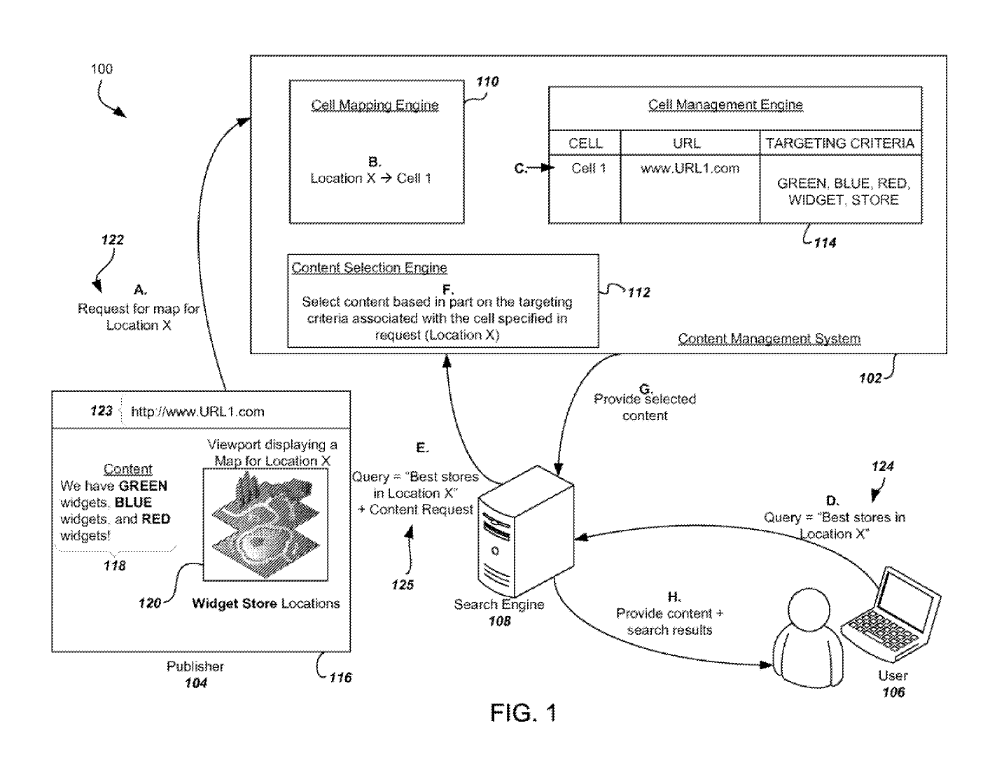

Briefly, techniques are disclosed for providing content based at least in part on geographic location data. In some examples, the content can be based on targeting criteria extracted from websites that request geographic location data in the form of a map of a geographic location (e.g., a map that is embedded on, or otherwise linked to the website, such as the map shown in FIG. 1). The geographic location can be mapped to a cell (e.g., a predefined geographic region that includes one or more geographic locations). The cell can be associated with targeting criteria. The targeting criteria can be extracted from one or more websites that request a map that includes the cell. For example, the cell may be associated with one or more keywords presented on such requesting web sites and/or Uniform Resource Locators (URLs) of such websites.

When future requests for providing content associated with the cell are received, the content can be selected based at least in part on the targeting criteria associated with the cell. For example, if a user visits a web page that includes a map of a geographic location that lies within (or includes) the aforementioned cell, content (e.g., advertisements) can be selected for display on the web page based on the targeting criteria associated with the cell.

FIG. 1 shows an example system 100 that includes a content management system 102, a publisher 104, a user 106, and a search engine 108. While only one instance of each entity is shown in FIG. 1, the system 100 can include additional content management systems, publishers, users, and search engines.

In some implementations, a computer network, such as a local area network (LAN), wide area network (WAN), the Internet, or a combination thereof, connects the content management system 102, the publisher 104, the user 106, and the search engine 108.

One example of a publisher 104 is a general content server that receives requests for information (e.g., articles, discussion threads, music, video, graphics, search results, web page listings, information feeds, etc.), and retrieves the requested information (i.e. published content) in response to the request. The content server may submit a request for advertising content (e.g., advertisements) to the content management system 102. The request for advertising content may include a number of content items desired. The request for advertising content may also include information describing the request for published content as further described below.

A search service, such as search engine 108, can receive queries from the user 106. In response, the search service can retrieve relevant search results from an index of documents (e.g., from an index of web pages). An example search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search engine 108 can submit a request for advertising content (e.g., advertisements) to the content management system 102. The request may include a number of advertising content items desired. This number may depend on the search results, the amount of screen or page space occupied by the search results, the size and shape of the advertising content items, etc. In some implementations, the number of desired advertising content items will be from one to ten, or from three to five. The request for advertising content may also include the received query (as entered or parsed), information based on the received query (such as geo-location information, whether the query came from an affiliate and if so an identifier of such an affiliate), and/or information associated with, or based on, the search results responsive to the received query. Such information may include, for example, identifiers related to the search results (e.g., document identifiers or “dociDs”), scores related to the search results (e.g., information retrieval (“IR”) scores), snippets of text extracted from the search results, full text of the search results, feature vectors of the search results, etc. In some implementations, IR scores can be computed from, for example, dot products of feature vectors respectively corresponding to a query and a search result, page rank scores, and/or combinations of IR scores and page rank scores, etc.

The search engine 108 can combine the search results with one or more of the advertising content items provided by the content management system 102. This combined information can then be forwarded to the user 106 that submitted the query. The search results can be maintained as distinct from the advertising content items, so as not to confuse the user between paid advertisements and presumably neutral search results.

Finally, the search engine 108 can transmit information about the content item(s), including when, where, and/or how the content item(s) were rendered, back to the content management system 102.

FIG. 1 illustrates a flow of data within the system 100 during a plurality of states A-H. In practice, the states A-H may occur in the illustrated sequence, or they may occur in a sequence that is different than the illustrated sequence.

Referring to FIG. 1, in some examples, a publisher 104 provides a web page 116 that includes published content 118. The web page 116 is identified by a URL 123 (i.e., “http://ww.URL1.com”) that can be used to retrieve the web page from the publisher 104 . In the example of FIG. 1, the published content includes textual information that describes products offered by a vendor or merchant of widgets associated with the publisher 104.

The web page 116 also includes a viewport 120 that displays an image, such as a map, of a geographic location. The viewport 116 can be defined by a latitude and longitude of its upper-left corner and a latitude and a longitude of its lower-right corner. A map displayed within the viewport corresponds to a geographic area defined by these corners of the viewport. In some examples, geographic locations that lie outside the viewport are not immediately displayed, but can be viewed by re-centering the map within the viewport (e.g., by scrolling or dragging the map image using an input device, such as a mouse).

In some examples, the viewport 120 is provided by an application programming interface (API) that can be embedded in the web page 116. In some examples, the viewport 120 may not contain all the data necessary to generate a map image, but may transmit one or more requests to one or more remote data sources (e.g., the content management system 102) in order to retrieve the data necessary to render the map of the geographic location. In some examples, these requests for map data can be used to generated targeting criteria that is associated with a geographic location, or a cell that represents or is associated with a geographic region that contains the geographic location.

In state A, an application associated with the publisher 104 (e.g., the API that generates viewport 120) transmits a request 122 to the content management system 102. The request 122 may be a request for a map for a location (e.g., map for Location X) which, as shown in FIG. 1, may be a geographic location of the publisher's store that sells widgets. In some examples, the request 122 may include one or more latitude and longitude coordinates that define the requested map data, or may include some other type of location data. The request 122 may be a referral from a map API associated with or embedded in the web page 116.

In state B, a cell mapping engine 110 associated with the content management system 102 extracts the location data specified in the request 122 and identifies one or more cells that contain or are associated with the geographic location specified in the request 122. For example, if “cell 1” represents a geographic region whose boundaries include Location X, the cell mapping engine 110 could map Location X to cell 1, as shown in FIG. 1. In some examples, a geographic location can be associated with more than one cell (e.g., a geographic location can be associated with a first cell, a second cell that includes the first cell, and so on). The hierarchical nature of cells will be discussed in greater detail below.

In state C, a cell management engine 114 updates a database that stores relationships between cells, targeting criteria, and URLs. For example, assuming cell 1 did not have any pre-existing associations in a database of the cell management engine 114, the cell management engine 114 can create a new entry (e.g., as a row in the database) for cell 1. In state C, the cell management engine 114 has added an association between cell 1, the URL 123 of the web page 116 (http://www.URL1.com), and targeting criteria extracted from the web page 116 (e.g., the keywords GREEN, BLUE, RED, WIDGET, AND STORE). In some implementations, the cell management system 114 may already contain some or all of the targeting criteria extracted from website 116 or from another website requesting a map that includes cell 1. For example, the content management system 102 (or another entity) could have previously extracted targeting criteria for cell 1 from the web site 116 during a previous interaction with the web site 116. The previously extracted targeting criteria could already associate cell 1 with the URL 123, and state C could include extracting additional targeting criteria for cell 1 from the web page 116.

In some implementations, targeting criteria for cell 1 can be extracted from the request 122 received from the web site 116. Additionally, targeting criteria can be extracted from additional exchanges with web site 116, from other websites that request a map of cell 1, or from search queries that include a location within cell1, non of which are not depicted in FIG. 1.

In some implementations, the storage of information in state C is done not on a cell basis, but rather on a location basis. That is, targeting information and URL designators can be associated with a particular location (e.g. Location X) and stored together for targeting content when future requests are received that relate to the location.

In state D, a user 106 submits a search request 124 to the search engine 108. In some examples, the search request 124 is a query that includes one or more key words that are entered into a search engine (e.g., www.google.com). In the example of FIG. 1, the user has submitted a search request 124 in the form of a keyword search that reads: “best stores in location X.”

In response to receiving the search request 124, the search engine 108 submits a request for advertising content 125 to the content management system 102 in state E. In some implementations, the request 125 includes the keywords from the search request 124. In some implementations, the request for advertising content 125 is a request for one or more advertising content items (e.g., advertisements) that will be presented to the user 106 along with results that satisfy the search request 124, such as one or more pages of search results. The request 125 may also specify a number of advertising content items (e.g., advertisements) that will be presented with the results.

In state F, a content selection engine 112 selects one or more advertising content items for presentation to the user based at least in part on the targeting criteria associated with a cell that includes or is associated with the location specified in the search request 124. For example, the user 106 has searched for information relating to the “best stores in location X.” The content selection engine 112 may identify the term “location X” as a geographic location, and may then cross-reference a database associated with the cell management engine 114 to identify one or more cells associated with location X, and any targeting criteria or URLs associated with those cells. In this example, the content selection engine 112 (along with, in some examples, one or more additional engines, such as the cell management engine 114) would determine that location X is within cell 1, and cell 1 is associated with the URL 123 (i.e., http://www.URL1.com) and the targeting criteria keywords GREEN, BLUE, RED, WIDGET, and STORE. The content selection engine 112 may then select one or more advertising content items (e.g., advertisements) to present with the search results that match the targeting criteria. For example, the content selection engine 112 could select (or increase the likelihood of selection of) advertisements that are associated with the keywords GREEN and WIDGET, such as an advertisement for a vendor of green widgets. In addition, or alternatively, the content selection engine 112 could select the URL 123 for presentation as an advertiser sponsored search result if the content of the web page 116 identified by URL 123 is responsive to the search request 124.

In state G, the content management system 102 provides the advertising content selected by the content selection engine 112 to the search engine 108. Using the example above, if the content selection engine 112 selected several advertising content items to present that are associated with the keywords GREEN and WIDGET (e.g., advertisements for a vendor of green widgets), the content management system 102 could transmit the selected advertising content items to the search engine 108 for inclusion in the search results page ultimately presented to the user 106. Alternatively, the content items can be provided directly to a user device associated with the search query (i.e., not by way of the search engine).

In state H, the search engine 108 provides content to the user 106 that may be relevant to the search request 124 submitted by the user 106 in state D, including both published content and advertising content. In some examples, the content provided to the user 106 in state H includes a list of search results (published content) as well as one or more of the advertising content items selected by the content selection engine 112 in state F. In some implementations, the search engine 108 can determine the manner in which to present the selected content items, for example, the search engine 108 can specify a position of one or more advertisements on a web page presented to the user 106 that includes search results.

The techniques described herein can be used to determine relevant keywords or other targeting criteria for a given cell or location. For example, when a web page for a vineyard in Napa Valley, California requests a map depicting the location of the vineyard, keywords such as “pinot,” “wine,” and “cabernet” can be extracted from the web page and associated with the Napa Valley location or one or more cells that are associated with the Napa Valley location of the vineyard.

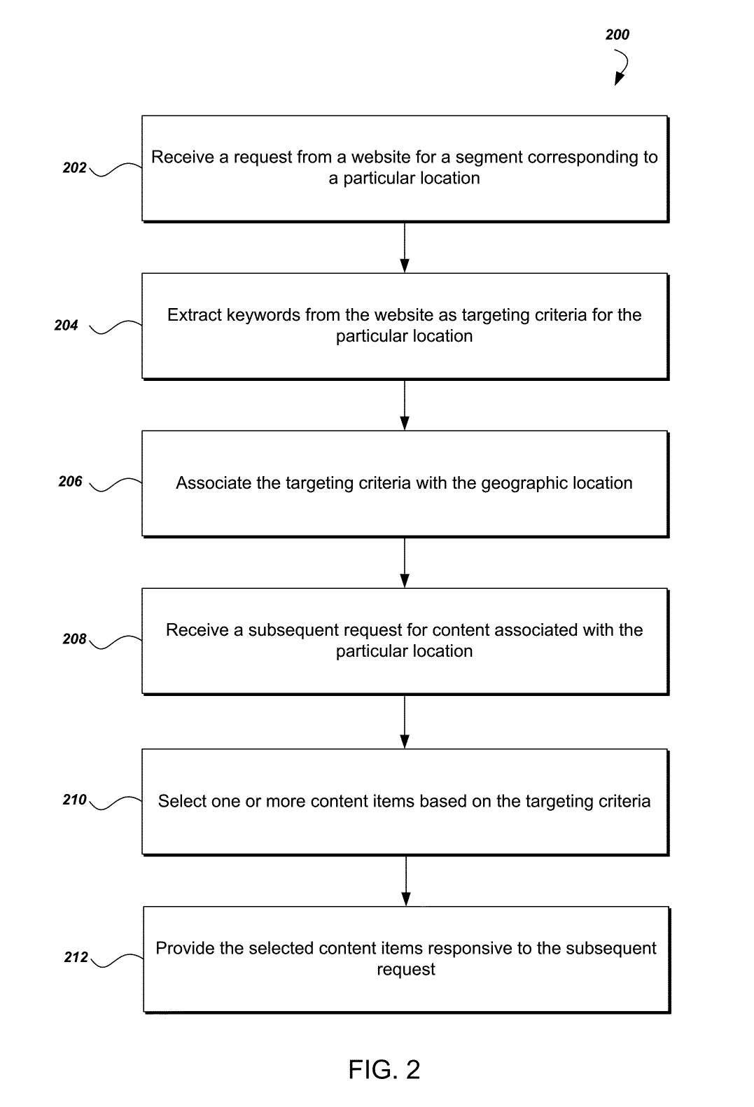

FIG. 2 illustrates an example process 200 for extracting location based targeting criteria. While in some examples the process 200 can be carried out by the content management system 102 (FIG. 1), it is possible that various aspects of the process 200 could be executed by one or more other entities, such as the search engine 108 (FIG. 1) or a second content management system or a mapping system.

Requests for content that include a geographic location of interest are received (202). For example, the content management system 102 may receive a request from an API associated with a website. In some examples, the request can be a request for map data used to render a map embedded in the website. The map API may send a request for the map data, and the request may include one or more geographic locations that specify a geographic region to be depicted in the rendered map. The request may also include a URL associated with the website.

At stage 204, targeting criteria can be extracted from the website in the form of keywords associated with the website or from the URL of the website.

The targeting criteria extracted from the website are associated with the geographic location (206). For example, the content management system 102 may create or update an entry in a database that includes associations between the geographic location and the extracted targeting criteria. The targeting criteria can be associated with the particular geographic location (e.g., a GPS coordinate) specified in the request from the website, or can be associated with a geographic region (e.g., the aforementioned “cell” or “cells”) that includes the specified geographic location. In some examples, in order to associate the targeting criteria with a cell, the content management system 102 may map the geographic location specified in the request to one or more cells.

In some examples, additional targeting criteria can be extracted from sources other than the requesting website, such as markers and information windows that are associated with the map requested by the website. For example, the requested map may include markers that identify specific locations such as restaurants and hotels. These markers may contain additional information about the specific location for which the map was requested (e.g., a restaurant marker may include reviews, menu information, and restaurant hours), and the additional information can be used as targeting criteria for the geographic region (e.g., the cell) that contains the marker. In some implementations, the content management system 102 can also associate targeting criteria with the geographic region based on previous user search queries for the region or based on websites that are responsive to such queries.

In some examples, the targeting criteria extracted from a web site that requests a map that includes more than one cell may be fractionally attributed to all of the cells. In such instances, the targeting criteria associated with a cell can be associated with a weight that indicates the importance or significance of the targeting criteria to the cell. For example, the cells displayed within a map viewport can be assigned a proportional share of the targeting criteria extracted from the website that requested the map, where the extracted targeting criteria is weighted by a factor of 1/N, where N is the total number of cells displayed within the viewport. In some examples, a map API may request several different map regions to be displayed in the website's viewport, for example, by issuing a sequence of AJAX queries as the user pans around the map displayed in the viewport. In this case, targeting content associated with the website can be fractionally attributed to all of the cells in all of the map regions displayed in the viewport. If multiple map regions are requested from a single website (e.g., as the user pans around the map), more weight can be assigned to the cells in the map regions where the user spends more time. For example, if the user is zoomed in on Napa, but pans to Sonoma, map cells from both geographic areas can be attributed the targeting criteria extracted from the website, weighted by both the amount of time spent viewing maps of each region, and the number of map cells in each region.

Returning to the process of FIG. 2, at stage 208, a subsequent request for content can be received where the request is associated with a given location. At stage 210, targeting criteria associated with the location are determined. For example, the location can be mapped to one or more cells, and targeting criteria for the cells can be retrieved. The targeting criteria can have been extracted and stored previously as discussed above. In some instances, the cells may not contain any targeting criteria. In these instances, cell hierarchies can be used to obtain targeting criteria from related cells. For example, a given cell (e.g., an S2 cell) may be divided into four child cells that depict a given region at higher resolution, and may be one of four cells that constitute a parent cell that depicts the region at a lower resolution. The contents of a “labeled” cell (e.g., a cell with associated targeting criteria) can be applied to one or more unlabeled cells that are related to it. For example, if a parent cell is unlabeled, targeting criteria can be aggregated from the parent cell's children (e.g., one or more of the four subdivided cells that make up the parent cell). If a child cell is unlabeled, the targeting criteria of its parent cell can be attributed to the unlabeled child cell, with each of the targeting criteria items weighted by some factor (e.g., 0.25). At stage 212, the targeting criteria can be used to select one or more advertising content items responsive to the request received in stage 208. At stage 214, selected advertisement content items can be provided responsive to the request.

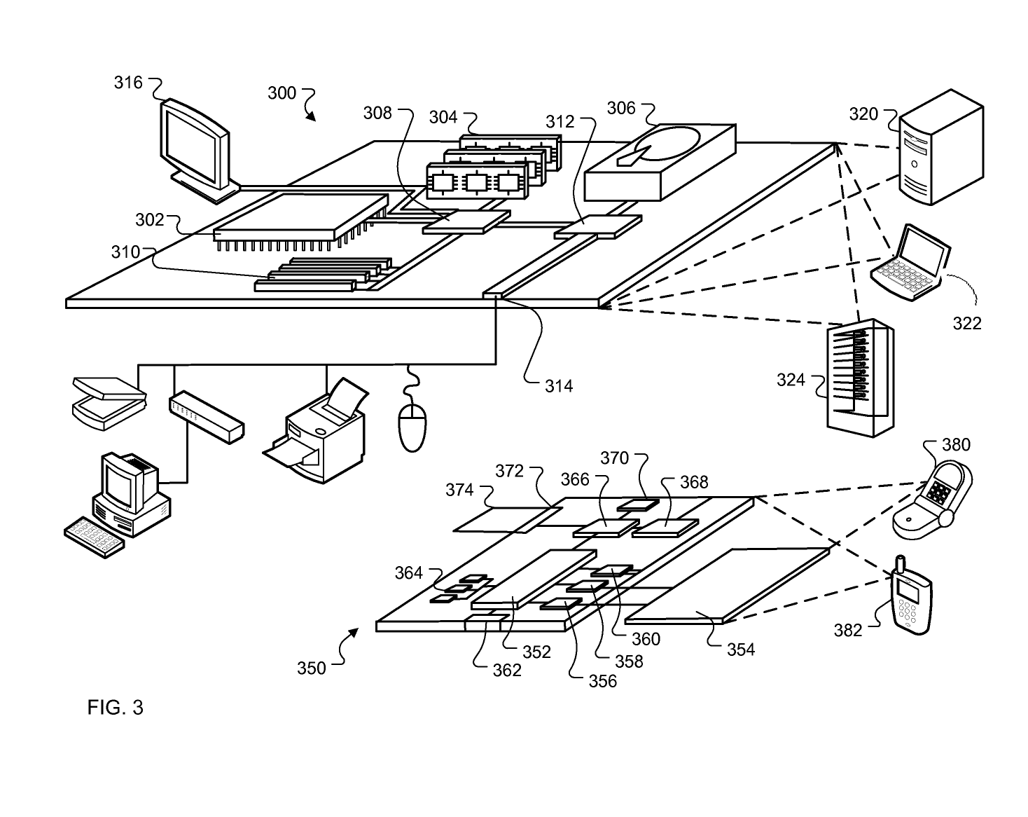

FIG. 3 shows an example of a computing device 300 and a mobile computing device 350 that can be used to implement the techniques described in this disclosure. The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine-readable mediums (for example, the memory 304, the storage device 306, or memory on the processor 302).

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device (not shown), such as a mobile computing device 350. Each of such devices may contain one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352).

The mobile computing device 350 may communicate wirelessly through the communication interface 366, which may include digital signal processing circuitry where necessary. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 368 using a radio-frequency. In addition, short-range communication may occur, such as using a Bluetooth, WiFi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, etc.) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving, at a content management system operative to provide online maps embedded in websites published by others and provide location-targeted advertisements, a request for a map segment corresponding to a particular geographic location, wherein the map segment is to be embedded in a publisher's website identified by the request;
after receiving the request, sending a request, from the content management system, to the publisher for at least part of a webpage of the publisher's website and, upon receiving the requested at least part of the webpage, extracting, by the content management system, keywords from the least part of the webpage;
associating, by the content management system, in memory, the keywords with the particular geographic location in response to the publisher's website both including the keywords in the webpage and embedding map segments corresponding to the particular geographic location;
receiving, at the content management system, a subsequent request for advertising content associated with given geographic location;
in response to the subsequent request, retrieving the keywords associated with the particular geographic location from the memory based on correlation between the given geographic location and the particular geographic location;
selecting, by the content management system, one or more advertising content items based on the keywords; and
providing, from the content management system, the selected advertising content items responsive to the subsequent request.

2. The method of claim 1, comprising selecting the one or more advertisement content items based on a Uniform Resource Locator (URL) of the publisher's website.

3. The method of claim 1, wherein associating the keywords with the particular_geographic location comprises associating the keywords with a map cell that includes the particular geographic location.

4. The method of claim 3, wherein selecting the one or more advertising content items based on the keywords comprises selecting the one or more advertising content items based on the keywords associated with the map cell that includes the given geographic location.

5. A computer-implemented method comprising:
receiving, at a content management system, a request for advertising content associated with a geographic location;
mapping, by the content management system, the geographic location to a map cell;
obtaining, at the content management system, targeting criteria for the map cell, wherein the targeting criteria are extracted from a website that displays a map that includes the map cell or a related map cell, wherein the targeting criteria are extracted from a portion of the website that is not served by the content management system and is retrieved from a publisher by the content management system, and wherein obtaining targeting criteria comprises:
determining that the map cell is not associated with any targeting criteria;
determining that the related map cell is associated with the targeting criteria, wherein the related map cell is a parent map cell that includes the map cell and is a lower resolution than the map cell; and
obtaining the targeting criteria from the related map cell;
selecting, at the content management system, one or more advertising content items based on the targeting criteria; and
providing, from the content management system, the selected advertising content items responsive to the request.

6-7. (canceled)

8. The method of claim 5, further comprising weighting the targeting criteria obtained from the related map cell.

9. A system comprising:
one or more memory devices storing instructions; and
one or more processors configured to execute the instructions stored in the one or more memory devices, wherein the instructions, when executed by at least some of the one or more processors cause the processors to execute a process comprising:
receiving a request for a map segment corresponding to a particular geographic location, wherein the map segment is to be embedded in a publisher's website identified by the request;
after receiving the request, sending a request to the publisher for at least part of a webpage of the publisher's website and, upon receiving the requested at least part of the webpage, extracting keywords from the least part of the webpage;
associating, in the one or more memory devices, the keywords with the particular geographic location in response to the publisher's website both including the keywords in the webpage and embedding map segments corresponding to the particular geographic location;
receiving a subsequent request for advertising content associated with a given geographic location;
in response to the subsequent request, retrieving the keywords associated with the particular geographic location from the one or more memory devices based on correlation between the given geographic location and the particular geographic location;
selecting, by the content management system, one or more advertising content items based on the keywords; and
providing the selected advertising content items responsive to the subsequent request.

10. The system of claim 9, comprising selecting the one or more advertisement content items based on a Uniform Resource Locator (URL) of the publisher's website.

11. The system of claim 9, wherein associating the keywords with the particular_geographic location comprises associating the keywords with a map cell that includes the particular geographic location.

12. The system of claim 11, wherein selecting the one or more advertising content items based on the keywords comprises selecting the one or more advertising content items based on the keywords associated with the map cell that includes the given geographic location.

13. A system comprising:
one or more memory devices storing instructions; and
one or more processors configured to execute the instructions stored in the one or more memory devices, wherein the instructions, when executed by at least some of the one or more processors cause the processors to execute a process comprising:
receiving a request for advertising content associated with a geographic location;
mapping the geographic location to a map cell;
obtaining targeting criteria for the map cell, wherein the targeting criteria are extracted from a website that displays a map that includes the map cell or a related map cell, wherein the targeting criteria are extracted from a portion of the website that is not served by the content management system and is retrieved from a publisher by the content management system, and wherein obtaining target criteria comprises:
determining that the map cell is not associated with any targeting criteria;
determining that the related map cell is associated with the targeting criteria, wherein the related map cell is a parent map cell that includes the map cell and is a lower resolution than the map cell; and
obtaining the targeting criteria from the related map cell;
selecting one or more advertising content items based on the targeting criteria; and
providing the selected advertising content items responsive to the request.

14-15. (canceled)

16. The system of claim 13, further comprising weighting the targeting criteria obtained from the related map cell.

17. The method of claim 1, comprising:
after receiving the request for the map segment, sending a plurality of map cells that collectively depict the map segment
wherein associating the keywords with the particular geographic location comprises:
associating the keywords with at least some of the map cells;
weighting the keywords based on an amount of map cells in the plurality of map cells such that an increase in the amount map cells tend to decrease the weighting of a keyword.

18. The method of claim 17, comprising:
receiving another request for another plurality of map cells due to a user panning a map viewport depicting the map segment embedded in the publisher's website,
wherein weighting the keywords based on an amount of map cells comprises weighting the keywords based on both a number of map cells among the plurality of map cells and another number of map cells among the other plurality of map cells.

19. The method of claim 1, wherein the request for the map segment comprises a request from a map viewport embedded in the publisher's website, the embedded map viewport including an application program interface call to the content management system to obtain data to generate a map image on a user device.

20. The method of claim 9, comprising:
after receiving the request for the map segment, sending a plurality of map cells that collectively depict the map segment
wherein associating the keywords with the particular geographic location comprises:
associating the keywords with at least some of the map cells;
weighting the keywords based on an amount of map cells in the plurality of map cells such that an increase in the amount map cells tend to decrease the weighting of a keyword.

21. The method of claim 20, comprising:
receiving another request for another plurality of map cells due to a user panning a map viewport depicting the map segment embedded in the publisher's website,
wherein weighting the keywords based on an amount of map cells comprises weighting the keywords based on both a number of map cells among the plurality of map cells and another number of map cells among the other plurality of map cells.

22. The method of claim 9, wherein the request for the map segment comprises a request from a map viewport embedded in the publisher's website, the embedded map viewport including an application program interface call to the content management system to obtain data to generate a map image on a user device.
